(19) United States
(12) Patent Application Publication
(10) Pub. No.: US 2016/0055827 A1
(43) Pub. Date: Feb. 25, 2016

(54) DISPLAY METHOD

(71) Applicant: SHARP KABUSHIKI KAISHA, Osaka (JP)

(72) Inventor: Minoru HAMADA, Osaka-shi (JP)

(73) Assignee: SHARP KABUSHIKI KAISHA, Osaka (JP)

(21) Appl. No.: 14/932,771

(22) Filed: Nov. 4, 2015

Related U.S. Application Data
(62) Division of application No. 13/819,644, filed on Feb. 27, 2013, now abandoned.

(30) Foreign Application Priority Data
Oct. 1, 2010 (JP) 2010-224270

(51) Int. Cl. G09G 5/14; G09G 5/32; G09G 5/00; G06T 3/60; G06F 3/0346

(52) U.S. Cl. CPC G09G 5/14; G06T 3/60; G06F 3/0346; G09G 5/003; G09G 5/32; G09G 2340/0492

(57) ABSTRACT

A display device having, in a single display screen, a first display area which requires power for displaying information, and a second display area, having a smaller dimension than the first display area and which requires power for displaying information. The display of each of the first and second display areas being selectively in an off-state or an on-state. The display device is configured to display, in the second display area, a display content relevant to an operation of a user or to information necessary for the user, in a case where the display of the first display area is in the on-state. In addition, the display device is configured to rotate an orientation of the display content as suitable for an orientation of the display device.

This application is a Divisional of copending application Ser. No. 13/819,644, filed on Feb. 27, 2013, which was filed as the National Stage of PCT International Application No. PCT/JP2011/072651 on Sep. 30, 2011, which claims the benefit under 35 U.S.C. §119(a) to Patent Application No. 2010-224270, filed in Japan on Oct. 1, 2010, all of which are hereby expressly incorporated by reference into the present application.

### TECHNICAL FIELD

The present invention relates to a display method for a display screen which is provided to a portable or a stationary display device.

### BACKGROUND ART

Nowadays, a display device has made rapid progress with advances of information processing technology and information transmission technology and made a major contribution to creation of various lifestyles. For example, a stationary display device such as a flat-screen television, a flat-screen monitor display, an in-vehicle display, or the like and a portable display device such as a mobile phone, a portable music player, PDA (Personal Digital Assistants), or the like have been widespread in our daily life as if they are day-to-day necessities.

Patent Literature 1 mentioned below discloses a display device in which plural kinds of flat-screen display panels are arranged on a single surface so that display of a portable device is improved in design and variety.

FIG. 8 is a cross-sectional view illustrating schematically an overall arrangement of a display device 100. The display device 100 includes a front substrate 101, which is made of a glass substrate, having a surface of a display viewing side (that is a front surface) and another surface, which is an opposite side to the front surface (i.e., another surface is a back surface). To the back surface, a first display panel 102 and a second display panel 103 are adhered by use of a UV hardening translucent glue 104 so as to be configured as a flat-screen display panel integrally.

An example of a combination of the first display panel 102 and the second display panel 103 is a combination of a liquid crystal display panel provided with a backlight and a reflective liquid crystal display panel.

Other examples of the combination described in Patent Literature 1 are a combination of a normally-white liquid crystal display panel and a normally-black liquid crystal display panel, a combination of an active matrix liquid crystal display panel and a passive liquid crystal display panel, or a combination of a liquid crystal display panel and an organic EL display panel. In addition, it is also described that the front substrate 101 can be configured to be a touch panel.

### CITATION LIST

### Patent Literature

Patent Literature 1
Japanese Patent Application Publication, Tokukai, No. 2009-163131 (Publication Date: Jul. 23, 2009)

### SUMMARY OF INVENTION

### Technical Problem

However, according to a display device disclosed in Patent Literature 1, it is conceived that, during a waiting mode or a power off mode, each of the first display panel 102 and the second display panel 103 is in an off-state and nothing is displayed on a display screen. For example, it is not considered at all to display constantly, even in the waiting mode or the power off mode, useful information for a user on the second display panel 103.

According to a display device such as the display device described in Patent Literature 1, for example, wherein a plurality of display panels are turned off at the same time, it is required for a user to input an instruction to cancel the waiting mode or the power off mode when the user wants to know a remaining amount of a built-in battery or what time it is.

Therefore, the display device in Patent Literature 1 is rich in variety of a display mode during an on-state of the display device, but the multiple display panels become useless during the waiting mode or the power off mode.

In addition, for example, a mobile phone having display panels on an interior surface and an exterior surface, respectively, the exterior surface on which the useful information for a user is displayed constantly, has already been distributed in a market. However, a configuration that a display panel is provided to each of the interior surface and the exterior surface disadvantageously makes it difficult to reduce the thickness of a mobile phone.

The present invention is accomplished in view of the problems above, and an object of the invention is to provide a first display area and a second display area on a single display screen, display the useful information for a user in the second display area having smaller area than the first display area, and enhance convenience of a display device by displaying constantly the useful information for a user in the second display area.

### Solution to Problem

In order to solve the problems above, a display method for displaying performed by a display device having, in a single display screen, (1) a first display area which requires power for displaying information, and (2) a second display area, having a smaller dimension than the first display area, which requires power for displaying information, and (3) including a housing surrounding the display screen, the housing having a surface on a same side of the display screen, on which surface any operating section for touch operation is not provided, (4) the method including displaying constantly information in the second display area regardless of whether the first display area is in the on-state or the off-state.

According to the above configuration, the second display area having relatively smaller area is suitable for supplementary display for the first display area. Therefore, as a first effect, it is possible to use the first display area as a main display area which displays information and, at the same time, display necessary or useful information for a user in the second display area, regardless of whether the display device is portable or stationary, or whether the first display area is in the on-state or the off-state.

Thus, when acquiring information a user wants to know (e.g. a remaining amount of a battery, the current time, or the like) from the display device, a user does not have to input an instruction to cancel the waiting mode or power off mode and only has to look at the second display area. Therefore, the convenience of the display device can be enhanced.

Note that, the necessary or useful information for a user includes information associated to a lifestyle of a user, for example, a forecast, an exchange rate, daily topic news, pictures liked by a user or the like.

Further, a design of the display device that any operating section for touch operation is not provided to a surface of a housing, which surface frames the display screen on the same side of the display screen, is a novel design which has never been seen in the past.

In this novel design, since the second display area is kept being in the on-state, a second effect can be obtained. In other words, regardless of whether the first display area is in the on-state or the off-state, it is possible to display constantly at least a soft key which is a substitute for an input button (a device for input only) in the second display area. Therefore, even if any operating section as mentioned above is not provided on the surface of the housing, which surface surrounds the display screen on the same side of the display screen, operability can be secured by the configuration in which the soft key substitute for the input button is displayed constantly. In other words, the frame framing the display screen can be narrower by this configuration, which does not provide the operating section while securing the operability of the display device equal to that of a conventional display device. Thus, narrowing the frame enhances potential of designing a bigger display screen.

In a case especially where the display device is portable, another two effects typical for a portable display device can be obtained in addition to those two effects.

In other words, according to such novel design described above, if no information is displayed on a display screen like a prior art during the waiting mode or the power off mode of a portable display device, it is difficult for a user to find out, at a glance to exterior appearance, which side of the portable display device should be upside to use the portable display device suitably.

As a first effect typical for the portable display device, displaying some kind of information in the second display area even during the waiting mode or the power off mode of the portable display device makes it easy for a user to find out which side of the portable display device should be upside to use the portable display device suitably. Therefore, it is possible to enhance the convenience of the portable display device.

Further, in a case where a display device is portable, a second effect typical for the portable display device can be obtained, in comparison to a method for providing a display screen to an inner surface and an outer surface of a frame respectively and displaying constantly information, for example, on the display screen on the outer surface. That is, since the first display area and the second display area are provided on a single display screen, the display method of the present invention contributes to realizing a thinner display device, which is capable of displaying constantly the useful information for a user.

On the other hand, in a case where a display device is stationary, in addition to the two effects, another effect typical for a stationary display device can be obtained.

That is, since the useful information or the like for a user can be constantly displayed on a part of the display screen, the display method of the present invention provides a completely different type of usage from an original use of the stationary display device, such as a television, a monitor display, an in-vehicle display, or the like. For example, as described above, information corresponding to lifestyle of a user such as the current time, a forecast, an exchange rate, daily topic news, pictures liked by a user, or the like can be provided constantly.

In a case where the first display area is in an on-state, it is preferable to change a display content of the second display area, according to a display content of the first display area or using conditions of the display device, in order to enhance convenience of the display device. In addition, the simpler the information displayed in the second display area becomes, the more power consumption can be reduced. In a case where the display device is portable, it is also possible to extend operating time of a battery.

Note that, combinations of a configuration recited in a certain claim and a configuration recited in other claim are not limited only to those combinations of the configuration recited in the certain claim and that recited in its dependent claim(s), but can be a combination of the configuration of the certain claim and the configuration of any other claim which is not dependent from the certain claim, as long as the object of the present invention can be attained.

### Advantageous Effects of Invention

As described earlier, a display method for displaying performed by a display device having, in a single display screen, a first display area which requires power for displaying information, and a second display area, having a smaller dimension than the first display area, which requires power for displaying information, and including a housing surrounding the display screen, the housing having a surface on a same side of the display screen, on which surface any operating section for touch operation is not provided, the method including displaying constantly information in the second display area regardless of whether the first display area is in the on-state or the off-state.

Thus, when acquiring information that a user wants to know, the user only has to look at the second display area without inputting an instruction to cancel the waiting mode or the power off mode. Therefore, this improves the convenience of the display device.

### BRIEF DESCRIPTION OF DRAWINGS

FIG. 1 is a plan view illustrating a configuration example of a display device of the present invention. (a) of FIG. 1 illustrates a first display area which is in an on-state. (b) of FIG. 1 illustrates the first display area which is in an off-state.

FIG. 2 is an explanatory view illustrating a display content displayed on a second display area when display of the first display area is off and a touch panel of the first display area is on.

FIG. 3 is an explanatory view illustrating a display content displayed on the second display area when the display of the first display area is off and the touch panel of the first display area is off.

FIG. 4 is an explanatory view illustrating how the display content of the second display area is changed over circularly by an instruction of a user during the first display area is in the off-state.

FIG. 5 is a functional block diagram illustrating schematically an inner configuration of the display device shown in FIG. 1.

FIG. 6 is an explanatory view illustrating schematically a configuration of one pixel composing the first display area.

FIG. 7 is an explanatory view illustrating schematically a configuration of a memory built-in pixel composing the second display area.

FIG. 8 is a side view illustrating schematically an overall configuration of a conventional display device.

### DESCRIPTION OF EMBODIMENTS

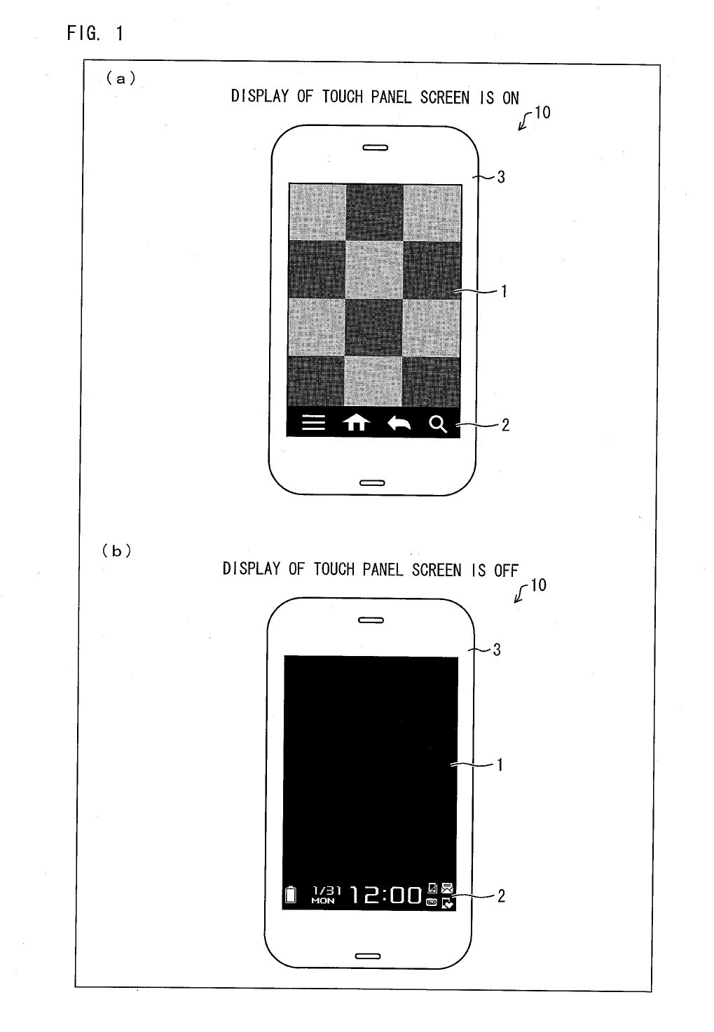

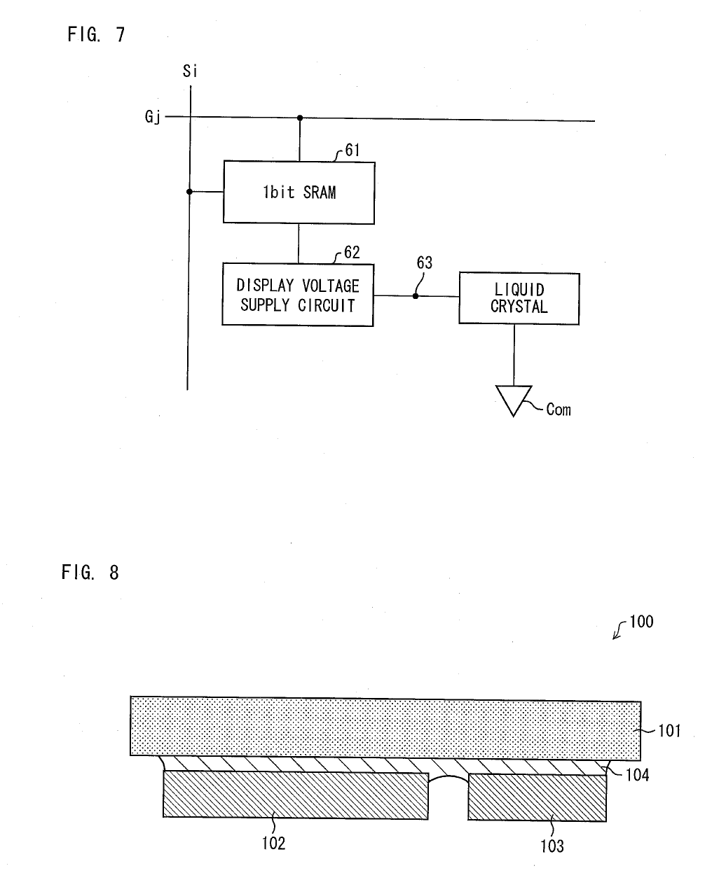

The following description will discuss an embodiment of the present invention, with reference to FIG. 1 and FIG. 7. Note that, unless otherwise specified, sizes, materials, shapes, relative positions, and the like of components described in the embodiment do not intend to limit the scope of the present invention but merely serve as examples for explanation.

(External Structure Common to Portable and Stationary Display Device)

FIG. 1 is a plan view illustrating a configuration example of a display device 10 of the present invention. The display device 10 includes: a first display area 1 in which pixels not having a memory function for keeping displaying a same display are arranged two-dimensionally; and a second display area 2 in which pixels having the memory function are arranged two-dimensionally, and the first display area 1 and the second display area 2 are provided on a single display screen.

The display device 10 includes a housing 3 which surrounds the display screen. A surface of the housing 3 on the same side as the display screen is not provided with any operating section for touch operation. Note that, the operating section for touch operation is an operating section which receives an instruction from a user by sensing a touch on the operating section with a finger or the like of a user.

The surface of the same side as the display screen of the housing 3 can be configured not to have an optional function section including an input/output section at all. Note that, “an optional function section including an input/output section” includes an input button for giving an instruction to the display device 10 by a user (a device for input only), a voice input device such as a microphone, a voice output device such as an earphone jack, and an input/output device such as a USB connector or an infrared data communication section.

The first display area 1 can be configured with an active matrix liquid crystal display panel, a passive liquid crystal display, an organic EL panel or the like. What is explained here is a case where an active matrix liquid crystal display panel with a touch panel function is employed in the first display area.

Further, the second display area 2 can be configured as a so-called memory liquid crystal display panel in which memory circuits for recoding display data are provided in a part of pixels or in every pixels of the second display area 2, respectively. As an alternative, the second display area 2 can be configured as a so-called electronic paper. What is explained here is a case where the second display area 2 is configured as a memory liquid crystal display panel with a touch panel function.

Note that, the memory liquid crystal display panel makes it possible to attain very low power consumption, compared to the active matrix liquid crystal display panel, because alternating current driving of the liquid crystal can be carried out at a lower frequency in the memory liquid crystal display panel.

In addition, the electronic paper can keep displaying even when the power is off and consume electric power only for rewriting a screen. Therefore, compared to the active matrix liquid crystal display panel or the organic EL panel, the electronic paper consumes a lower amount of power. Note that, a means of displaying of an electronic paper includes an electrophoresis system, an electronic powder and granular (Denshi-Funryutai; registered trademark) system, a liquid crystal display system, and the like. Further, the liquid crystal display system includes a ferroelectric liquid crystal system, a polymer dispersed liquid crystal system, and the like.

(Configuration Typical for Portable Display Device)

In a case where the display device 10 is a portable display device, the housing 3 further has a distinguishing feature. Namely, when viewed in plane from above in a direction vertical to the display screen, an exterior appearance of the housing 3 and the display screen has a symmetry shape whose upside and downside, and left side and right side are not distinguishable. Note that, on a surface of the housing 3 on the same side as the display screen, an operating section for touch operation does not need to be provided, an optional functional section including an input/output section can be arranged symmetrically, or any of such functional sections does not have to be provided at all.

The display device 10 illustrated as an example in FIG. 1, which is a display device having a function of a mobile phone, is provided with openings for mouthpiece and earpiece on upper part and lower part of the surface of the frame on the same side as the display screen, respectively. However, since any operating section is not provided, a novel design which is symmetry about up and down, left and right can be adopted to an exterior appearance of the display device.

In a case where the optional operation section including the input/output section is not provided at all and at the same time an exterior appearance around the display screen has a symmetry shape, the frame framing the display screen can be narrowed to a minimum necessary, thereby making it possible to enhance potential of designing a bigger display screen. This effect is effective for the stationary display device, but more remarkably effective for the portable display device.

Further, a back surface of the housing 3, namely, a surface opposite to the front surface in a case where the display screen is considered to be the front surface, is not provided with any other display screen. Therefore, the display device 10 can be thinner than a display device which is provided with display screens on a front surface and a back surface of a housing, respectively.

(Example of Display State of Display Device—On-State of First Display Area)

(a) of FIG. 1 illustrates a state of a first display area 1 which is supplied with power and is in a display mode. That is, a liquid crystal display panel and a touch panel are in an on-state. (b) of FIG. 1 illustrates a state of the first display area 1 which is supplied with limited power or not supplied with power and is in a waiting mode (including a power saving mode, a sleep mode, a standby mode, or the like) or a power off mode. That is, the liquid crystal display panel is in an off-state and the touch panel is in the on-state, or the liquid crystal display panel and the touch panel are in the off-state.

Regardless of whether the first display area 1 is in the display mode, the waiting mode, or the power off mode, a second display area 2 constantly (i.e., all the time) perform the display operation, which displays the display content that corresponds to the mode of the first display area 1.

For example, in a case where the first display area 1 is in the display mode as shown in (a) of FIG. 1, the second display area 2 shows icons indicating operation keys for a user to operate the display device 10.

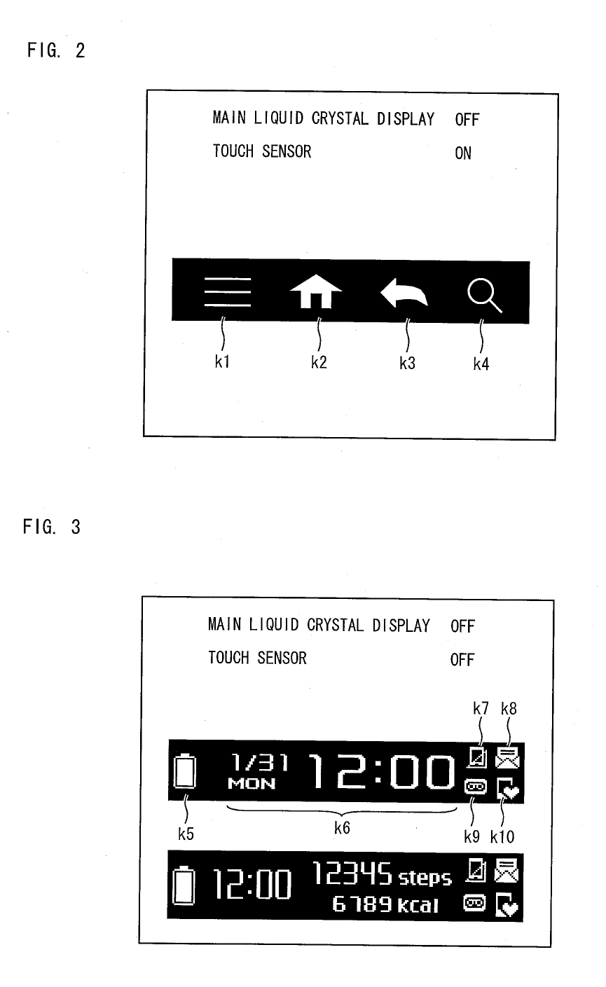

More specifically, on an initial screen displayed when the first display area 1 is turned on, the second display area 2 shows constantly various operation keys for carrying out basic operations on the display device 10. Examples of the various operation keys for basic operations are, as shown in FIG. 2, an operation key k1 for calling operation menus (a menu key), an operation key k2 for calling the initial screen (a home key), an operation key k3 for returning to a previous display screen from a present display screen (a back key), an operation key k4 for ordering an internet search (a search key), and the like.

In addition, when a user selected one of the operation menus called by the operation key k1 and its associating application is activated, operation keys constantly displayed in the second display area 2 are changed to operation keys for the application only.

In this manner, because operation keys which are necessary for a user to operate the display device 10 can be kept displayed at low electric consumption in the second display area 2, the front surface of the housing 3 is not required to be provided with any operation keys at all. This effect is remarkable in a case where the display device 10 is portable.

In an example of FIG. 1, the second display area 2 subserves the first display area 1 and is provided with a smaller dimension than the first display area 1. However, the present invention is not limited to this embodiment, but a dimension of the second display area 2 can be equal to that of the first display area 1 or larger than that of the first display area 1.

For example, in a case where a moving image is displayed in the first display area 1, the second display area 2 can be configured to keep displaying a description relevant to the moving image or a still-imaged information relevant to the moving image for long hours. This makes it possible for a user to deepen an interest in the moving image or knowledge relevant to the moving image by looking at the moving image displayed in the first display area 1 and information displayed in the second display area 2 at the same time.

By the way, the operation keys displayed in the second display area 2 are rotated to change its orientation according to whether the display device 10 is used with its long sides in vertical orientation or horizontal orientation.

As shown in FIG. 1, when the display device 10 is used with its long sides in the vertical orientation, the second display area 2 appears at a bottom of the display screen, namely, beside a short side of the display device 10. The operation keys are also displayed as suitable for the vertical orientation.

On the other hand, when the display device 10 is used with its long sides in the horizontal orientation, the second display area 2 appears beside the short side of the display screen likewise, so where the operation keys is displayed on the screen does not change (not shown). However, the operation keys changes their orientation by turning around at 90 degrees as suitable for the horizontal orientation. This improves operability of the display device 10.

(Example of Display State of Display Device—Off-State 1 of First Display Area)

(b) of FIG. 1 illustrates the first display area 1 which is in the waiting mode or the power off mode. When the first display area 1 is in the waiting mode or the power off mode, it is possible to display, in the second display area 2, information that is needed to be displayed long (e.g. a document that a user takes time to read it, an image that a user wants to watch for a long time, or the like), necessary information for a user, or useful information for a user at low consumption for long hours or constantly.

Concrete examples for the necessary information or the useful information for a user are a battery remaining amount display item k5, a date and hour display item k6, a missed call display item k7, an unread email display item k8, a voice record display item k9, a manner mode display item k10, and the like. Such information is displayed constantly in the second area 2, as illustrated in FIG. 3.

Specially, in a case where the display device 10 is portable, a user can only look at the second display area 2 without taking time to input an instruction to cancel the waiting mode or the power off mode in order to obtain information (e.g. a remaining amount of battery, a missed call, the current time, or the like). Therefore, convenience of the display device 10 can be enhanced.

In a case where the display device 10 is stationary, the display device 10 can provide a completely different type of usage from its original application use, as already explained above.

A typical effect can be further obtained in a case where the display device 10 is portable and an exterior appearance of the housing 3 and the display screen has a symmetry shape whose upside and downside, or left side and right side are not distinguishable when viewed in plane from above in a direction vertical to the display screen (see FIG. 1). In other words, even when the display area 1 is in the waiting mode or the power off mode, because some kind of information is constantly displayed in the second display area 2, the information constantly displayed makes it possible for a user to find out quickly in which way a portable display device should be oriented to be used suitably.

Thus, the present invention can provide a novel and unconventional design of a portable display device that an exterior appearance of a display screen has a symmetry shape irrespective of up and down, left and right when viewed in plane from above in a direction vertical to the display screen.

(Example of Display State of Display Device—Off-State 2 of First Display Area)

Next, the following description will discuss an example of a method for changing a display content of the second display area 2 in accordance with combinations of on/off of a liquid crystal display panel and a touch panel (a touch sensor) of the first display area 1.

FIG. 2 is an explanatory view illustrating a display content (a first display content) of the second display area 2 in accordance with a condition that display of the first display area 1 is in the off-state and the touch panel of the first display area 1 is in the on-state. In addition, FIG. 3 is an explanatory view illustrating a display content (a second display content) of the second display area 2 in accordance with a condition that the display of the first display area 1 is in the off-state and the touch panel of the first display area 1 is in the off-state.

It is impossible for a user to distinguish whether the touch panel of the first display area 1 is on or off simply by looking at the first display area when the display of the first display area 1 is turned off. It is preferable to keep the touch panel on during the waiting mode of the display device 10 so that the display device 10 can be always ready for input while the display of the first display area 1 is turned off to save electricity.

Accordingly, when the first display area 1 is off and the touch panel of the first display area 1 is on, it is preferable to display in the second display area mainly the operation keys such as the operation keys k1 through k4 so that a user can give some kind of instructions to the display device 10 (see FIG. 2).

On the other hand, when the display of the first display area 1 is off and the touch panel of the first display area 1 is off, the display device 10 is not required to be operated for a while. Because of this, it is preferable to display in the second display area mainly display items such as display items k5 through k10, or the like as the necessary or the useful information for a user (see FIG. 3).

This further enhances the convenience of the display device 10.

(Example of Display State of Display Device—Off-State 3 of First Display Area)

When the first display area 1 is off and the touch panel of the first display area is off, one of the aims of the present invention is to display constantly the necessary information or the useful information for a user in the second display area 2.

According to this aim, since the necessary information or the useful information for a user is various, it is preferable that a display content of the second display area 2 is not only one but has a plurality of optional patterns from which a user can select information.

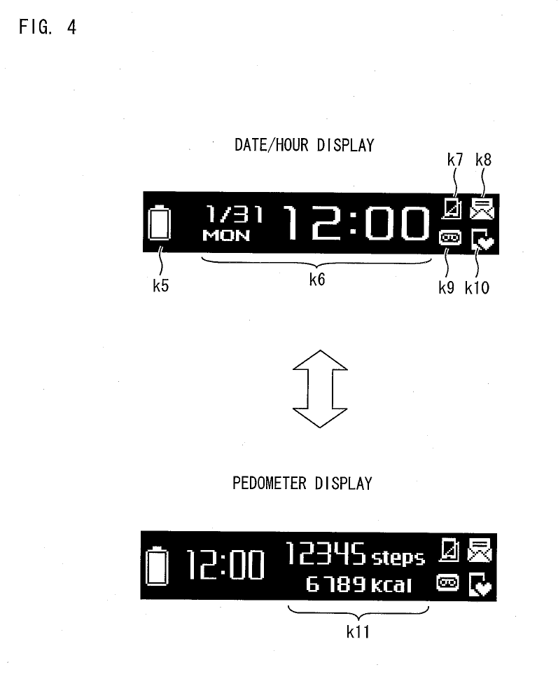

FIG. 4 is an explanatory view illustrating how a display content of the second display area 2 is changed over circularly by an instruction of a user (toggle input) while the first display area 1 is in the off-state.

According to an example of FIG. 4, (i) a first pattern of display, in which all sorts of display items k5 through k10 are displayed, and (ii) a second pattern of display, in which a month/day part of the date and hour display item k6 is changed to a pedometer/calorimeter display item k11, are changed over every time a user inputs an instruction to change over the patterns.

However, the number of patterns is not limited to two patterns, and three or more patterns can be changed over circularly. For example, three or more patterns can include a schedule of the day, all sorts of memos that should be checked on the day, or the like.

In this matter, the display content of the second display area 2 is not limited to a default pattern, but can be customized to fit a user's needs. The display content can be customized to fit a user's needs by use of the touch panel of the first display area 1 as an input means. Any kind of contents such as a document directly entered by a user, a copied document, an image acquired from outside of the display device 10, or the like, can be set as the display content of the second display area 2. The customized display content of the second display area 2 is constantly displayed in a way the number of pixels and fineness of the second display area 2 permit.

(Inner Structure of Display Device)

The following will discuss a summary of an inner structure of the display device 10 which allows display behavior described above. Note that, the inner structure of the display device 10 described below is merely an example and can be altered to variety of combinations with other devices described earlier.

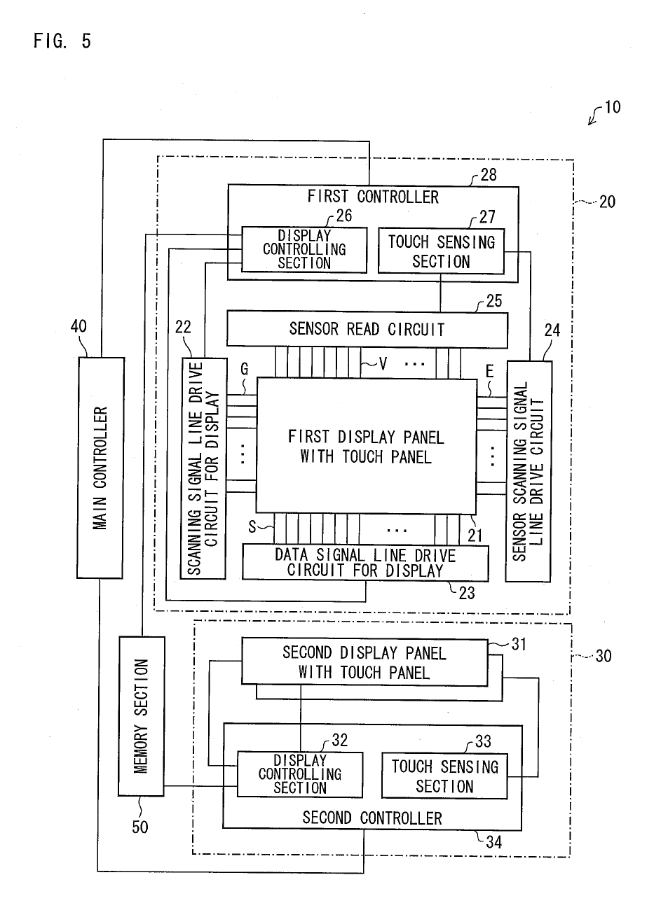

FIG. 5 is a block diagram illustrating schematically an inner structure of the display device 10 of FIG. 1. The display device 10 is provided with a first displaying section 20 configured to be an active matrix liquid crystal display device, and a second displaying section 30 configured to be a memory liquid crystal display device.

The first displaying section 20 includes a first display panel 21 attached with a touch panel corresponding to the first display area 1 (hereinafter referred to as a first display panel 21), a display scanning signal line drive circuit 22, a display data signal line drive circuit 23, a sensor scanning signal line drive circuit 24, a sensor read circuit 25, and a first controller 28 which is provided with a display controlling section 26 and a touch sensing section 27.

The second displaying section 30 includes a second display panel 31 attached with a touch panel corresponding to the second display area 2 (hereinafter referred to as a second display panel 31) and a second controller 34 which is provided with a display controlling section 32 and a touch sensing section 33.

In addition, the display device 10 is provided with a main controller 40 for supervising the first controller 28 and the second controller 34, a memory section 50 (a storing section) which is composed of a ROM, a RAM, et al., or the like. It may be configured such that the first controller 28 also serves as the main controller 40.

Each of the first display panel 21 and the second display panel 31 is provided with a plurality of gate lines G and a plurality of source lines S, each of which are crossed, and with pixels which are provided corresponding to respective intersections of the each of the plurality of gate lines G and the source lines S.

The display controlling section 26 generates a data signal, in accordance with a display data transmitted from the outside, and outputs various sorts of control signals and clock signals for controlling the display scanning signal line drive circuit 22 and the display data signal line drive circuit 23.

The display scanning signal line drive circuit 22 outputs sequentially to each of the gate lines G a scanning signal for selecting pixels for writing of data. The display data signal line drive circuit 23 outputs data signals to the source lines S, respectively.

The touch sensing section 27 outputs to the sensor scanning signal line drive circuit 24 a timing signal for controlling operation timing of the sensor scanning signal line drive circuit 24, and analyzes a distribution of sensor detection results over a plane of the first display panel 21 in accordance with sensor output voltages read by the sensor read circuit 25.

The sensor scanning signal line drive circuit 24 outputs sequentially a scanning signal for activating a sensor circuit to sensor scanning signal lines E so that each of the sensor scanning signal lines E can be activated line-sequentially. The sensor read circuit 25 reads out sensor output voltage from sensor output lines V.

On the other hand, the second displaying section 30 is configured such that the display controlling section 32 and the touch sensing section 33 control display and a touch sensing of the second display panel 31 directly not via a drive circuit. In the case of data writing in which the display controlling section 32 specifies addresses of only a gate line and a source line which require data update and writes data in a memory circuit of a pixel thus specified by the address, it is not necessary to install a drive circuit such as the display scanning signal line drive circuit 22 and the display data signal line drive circuit 23 which are provided to the first displaying section 20.

Note that, it is possible to select an optional system such as electrostatic capacitive coupling system, resistive membrane system, light sensor system, or the like as a position detecting system of each touch panel of the first displaying section 20 and the second displaying section 30.

(Configuration of Pixel in First Display Area)

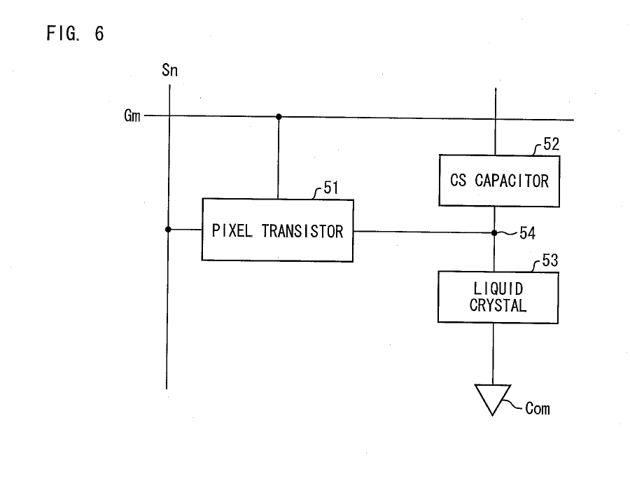

FIG. 6 is an explanatory view illustrating schematically a configuration of a pixel composing of the first display area 1. FIG. 6 illustrates a typical configuration of a pixel of an active matrix liquid crystal display device.

A data signal supplied to the source lines Sn is written into a CS capacitor 52 and a liquid crystal capacitor 53 by turning a pixel transistor 51 on/off. Display is carried out by applying voltage between a pixel electrode 54 and a common electrode Com to liquid crystal.

In order to avoid an effect of electrical potential change of the pixel electrode 54 caused by leak current of the pixel transistor 51, it is usually necessary to resupply (rewrite data) a data signal to a pixel at a frequency of 60 Hz or the like. At the time of rewriting the data, power is consumed because (i) current charging or discharging capacitance of each of the gate lines Gm and the source lines Sn and (ii) operating current at the peripheral circuits are caused by the operation of the peripheral circuits.

(Configuration of Pixel in Second Display Area)

FIG. 7 is an explanatory view illustrating schematically a configuration of a built-in memory pixel composing the second display area 2. Pixel regions are formed so as to correspond to respective intersections of gate lines Gj and source lines Si. Each pixel is provided with a memory circuit (e.g. 1 bit SRAM or DRAM) 61, which is specified by a gate line Gj, in which data is written by the source lines Si, and is provided with a display voltage supply circuit 62 having an inversion function.

Since the display voltage supply circuit 62 supplies the display voltage to a pixel electrode 63 in accordance with data stored in the memory circuit 61, it is possible to maintain display quality by setting an inversion period of the liquid crystal at low frequency of 1 Hz.

Only in a case where the display data is rewritten, it is required to activate the peripheral circuits to update data of the memory circuit 61. Here, the charge and discharge current occurs for the capacitance of each of the gate line Gj and the source line Sj, and the operating current occurs at the peripheral circuits. However, in a case where the display data is not required to be rewritten such as a still image display, an operation to rewrite the data in a regular period is necessary in the pixel of the active matrix liquid crystal display device but is not necessary in the built-in memory pixel because the display voltage supply circuit 62 keeps supplying display voltage to the pixel electrode 63.

This allows the memory liquid crystal display device to consume a much lower amount of power than the active matrix liquid crystal display device.

(Supplementation of Display Method of Second Display Area)

Further, the second display panel 31 is configured to serve as a reflective liquid crystal display panel which uses outside light as a light source required for display. Specially, the second display panel 31 is configured to be a reflective liquid crystal display panel without using a polarizer by adopting PNLC technology (Polymer network Liquid Crystal).

According to PNLC technology, when a liquid crystal layer is not applied with voltage, liquid crystal molecules are oriented irregularly, and light which entered the second display panel 31 from the outside is defused in the liquid crystal layer. Thus, the display panel can be in a cloudiness state (a white display).

On the other hand, when the liquid crystal layer is applied with voltage, the liquid crystal molecules oriented irregularly are oriented vertically to a display screen, whereby the display panel becomes transparent. Thus, the light which entered the second display panel 31 from outside goes through the liquid crystal layer, and is reflected by a reflector realizing a mirror display or a black display which is reflective like a mirror.

In this system, loss of light caused by a polarizer will not occur. Thus, this system can realize a bright display having 50% of reflectivity. The brighter the outside light is, the brighter and clearer the display of the second display area 2 can be. Therefore, the system is also suitable for a use as an electronic paper used in the bright outdoor.

Note that, the second display area 2 is not limited to a monochrome type performing a black-and-white display, but can be configured to be a color type performing a color display.

(Display Content Change Operation 1 in Second Display Area)

The memory section 50 stores (i) display data for displaying display contents to be displayed on the second display area 2 according to the combination of on and off states of the liquid crystal display panel and the touch panel of the first display area 1 or (ii) display data for displaying display contents to be displayed on the second display area 2 according to types of applications.

The main controller 40 (i) detects whether the liquid crystal display panel and the touch panel of the first display area 1 are on or off, and (ii) conveys a detection result to the display controlling section 32 of the second displaying section 30. Or, the main controller 40 (i) grasps which application is running, and grasps an analysis result made by the touch sensing section 27 on user's operation inputted via the first display panel 21 and (ii) notifies the display controlling section 32 of the running application and the analysis result.

Based on what is notified, the display controlling section 32 reads out, from the memory section 50, a display content corresponding to an operation status of the first display area 1, and causes the second display panel 31 to display the display content.

(Display Content Change Operation 2 in Second Display Area)

Next, the following will discuss an operation of changing the display content of the second display area 2 to a display content which a user prefers. Note that, a display content (contents) which a user wants to display in the second display area 2 is assumed to have been stored in the memory section 50 by an operation of a user via the first display panel 21.

For example, a user touches the operation key k1 illustrated in FIG. 2 so as to call a menu for selecting which display content to be display in the second display area 2, a display content of a default setting or a display content of a user setting. The menu called appears on the first display panel 21. In a case where the user setting is selected, the display controlling section 26 reads out from the memory section 50 a list of display contents which can be displayed in the second display area 2 or thumbnail images or the like of the display contents, and displays the list or the thumbnail images or the like on the first display panel 21.

When a user selects one or a plurality of display contents on the list displayed on the first display panel 21, or when the user selects one or a plurality of the thumbnail images or the like displayed on the first display panel 21, the selection is notified to the display controlling section 32 via the touch sensing section 27 and the main controller 40.

Based on what is notified, the display controlling section 32 reads out data of the display content thus selected and causes the second display panel 31 to perform display operation according to the data. It is possible to change the display content of the second display area 2 to the display content which a user prefers in such a way described above.

The following will provide supplementary explanation to the description of the display method of the present invention described above.

In a display method of the present invention, the display device is a portable display device, and an exterior appearance of the housing and the display screen has a symmetry shape whose upside and downside, and left side and right side are not distinguishable when viewed in plane from above in a direction vertical to the display screen.

According to the configuration, any operating section for touch operation is not provided on a surface of the housing on the same side of the display screen and an exterior appearance of the housing surrounding the display screen has a symmetry shape whose upside and downside, and left side and right side are not distinguishable from the exterior appearance.

If the display device described in Patent Literature 1 mentioned above is configured as such, nothing is displayed on a display screen during a waiting mode or a power off mode, as a result of which a user cannot find out from the exterior appearance which orientation is suitable for use of the potable display device. In other words, this can cause such an inconvenience for a user that the user finds out the portable display device is upside down, when canceling the waiting mode or the power off mode.

On the contrary, the present invention makes it possible to display constantly some kind of information on the second display area even during the waiting mode or the power off mode. Therefore, the information constantly displayed makes it easy for a user to find out the suitable orientation of the portable display device for using the portable display device.

This allows the present invention to provide a novel design of a portable display device, which has never been seen conventionally, namely a design having a symmetry shape whose upside and downside, and left side and right side are not distinguishable when viewed in plane from above in a direction vertical to the display screen.

In the display method of the present invention, information displayed constantly in the second display area is identical to a display content selected by a user from a plurality of display contents stored in a storing section of the display device, or information corresponding to the display content selected by a user

According to the configuration, it is possible to display constantly, on the second display area, a display content useful for a lifestyle of a user or information corresponding to the display contents from among a plurality of display contents stored in the storing section of the display device.

Note that, the plurality of display contents stored in a memory section include optional types of contents, as described above, such as a remaining amount of a battery, the current time, a forecast, an exchange rate, daily topic news, a document (a memo) that a user directly inputted, a copied document, an image acquired from the outside of the display device, or the like.

“Display content selected by a user” differs from “Information corresponding to a display content selected by a user” in a point whether information displayed in the second display area remains unchanged without being updated or changes after being updated. For example, a display content such as a document and a still image does not change with time, so that it is exactly the display content selected by the user. On the other hand, a remaining amount of a battery, the current time, or the like changes with time, so that they are classified into the information corresponding to a display content selected by a user.

The display method of the present invention may be configured such that at least the first display area includes a touch panel, and that, when display of the first display area is off and a sensing of the touch panel is on, information of a first display content is displayed constantly on the second display area, and when the display of the first display area is off and the sensing of the touch panel is also off, information of the second display content which is different from the first display content is displayed constantly on the second display area.

With such a configuration that a touch panel is provided to the first display area, a display device operates such that, when the first display area is not supplied with voltage for displaying, display of the first display area is in the off-state (e.g. a black display for normally-black system, a white display for normally-white system) and that the sensing of the touch panel can be set to either on-state or off-state.

However, since the display of the first display area is in the off-state, a user cannot find out whether the sensing of the touch panel is on or off by looking at the display in the first display area.

On the contrary, according to the present invention, in a case where the display of the first display area is turned off, information corresponding to each state of the on-state or the off-state of the touch panel is displayed constantly on the second display area. Therefore, a user can easily tell that the sensing of the touch panel is in the on-state or the off-state according to whether the display content of the second display area is the first display content or the second display content.

In the display method of the present invention, the information displayed constantly on the second display area changes circularly in accordance with an instruction for the display device by a user.

In other words, as a type of a content of the information displayed constantly in the second display area, at least 2 types, preferably, 3 or more types of contents are made available. This makes it easy for a user to select the information which is to be displayed constantly by giving an instruction to the display device looking at the second display area so that the content of the information displayed constantly on the second display area changes over circularly (toggle system). As a result, convenience of the display device can be further enhanced.

The present invention is not limited to the description of embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is applicable to portable or stationary display devices.

### REFERENCE SIGNS LIST

1 First Display Area
2 Second Display Area
3 Housing
10 Display Device
21 First Display Panel (First Display Area)
31 Second Display Panel (Second Display Area)
50 Memory Section (Storing Section)

1. A display method for displaying performed by a display device having, in a single display screen, a first display area which requires power for displaying information, and a second display area, having a smaller dimension than the first display area, which requires power for displaying information,
display of each of the first and second display areas being selectively in an off-state or an on-state,
the method comprising the steps of:
displaying, in the second display area, a display content relevant to an operation of a user or to information necessary for the user, in a case where the display of the first display area is in the on-state; and
rotating an orientation of the display content as suitable for an orientation of the display device.

2. The method as set forth in claim 1, wherein the display content displayed in the second display area changes over circularly in accordance with an instruction from the user to the display device.

3. The method as set forth in claim 1, wherein, in a case where an application is activated, the display content is changed to an operation key for operating the application.

4. The method as set forth in claim 1, wherein the display content displayed in the second display area is changed in accordance with an operation conducted with respect to the display content.
